(19) United States
(12) Patent Application Publication
(10) Pub. No.: US 2011/0316780 A1
(43) Pub. Date: Dec. 29, 2011

(54) MULTI-FUNCTIONAL MOUSE

(75) Inventors: Kun-Tsan WU, Shindian (TW); Li-Wen TIEN, Shindian (TW)

(73) Assignee: FIH (HONG KONG) LIMITED, Kowloon (HK)

(21) Appl. No.: 12/878,212

(22) Filed: Sep. 9, 2010

(30) Foreign Application Priority Data
Jun. 28, 2010 (CN) 201020239722.X

(51) Int. Cl. G09G 5/08

(52) U.S. Cl. 345/163

(57) ABSTRACT

A multi-functional mouse includes an upper housing, a lower housing mounted to the upper housing, a first interface, a second interface, an audio output module and an audio input module. The mouse electronically communicates with the electronic device.

### CROSS-REFERENCE TO RELATED APPLICATIONS

This application is related to co-pending U.S. Patent Applications (Attorney Docket No. US33681, AND US33682), all entitled “MULTI-FUNCTIONAL MOUSE”, by Wu et al. These applications have the same assignee as the present application and have been concurrently filed herewith. The above-identified applications are incorporated herein by reference.

### BACKGROUND

1. Technical Field

This disclosure relates to multi-functional mice.

2. Description of Related Art

Modern desktop computers provide users with user-input mechanisms that are well suited for the applications that run on these computers. For example, the desktop computers often use an external peripheral device, such as a mouse, that allows the user to conveniently navigate through menus of an application, as well as allowing navigation between applications and selection of various choices via a “click and drag” manner. However, most typical mice have only a navigation function.

Therefore, there is a room for improved in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary multi-functional mouse for electronic device. Moreover, in the drawings like reference numerals designate corresponding parts throughout the several views. Wherever possible, the same reference numbers are used throughout the drawings to refer to the same or like elements of an embodiment.

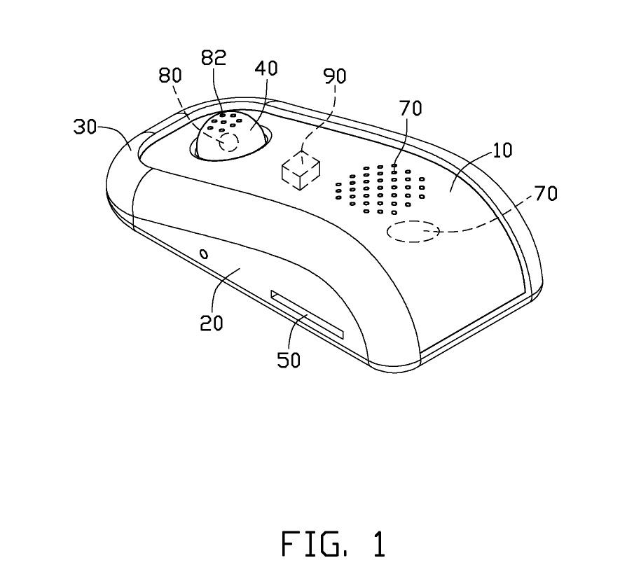

The FIG. 1 is a schematic view of an exemplary embodiment of a multi-functional mouse.

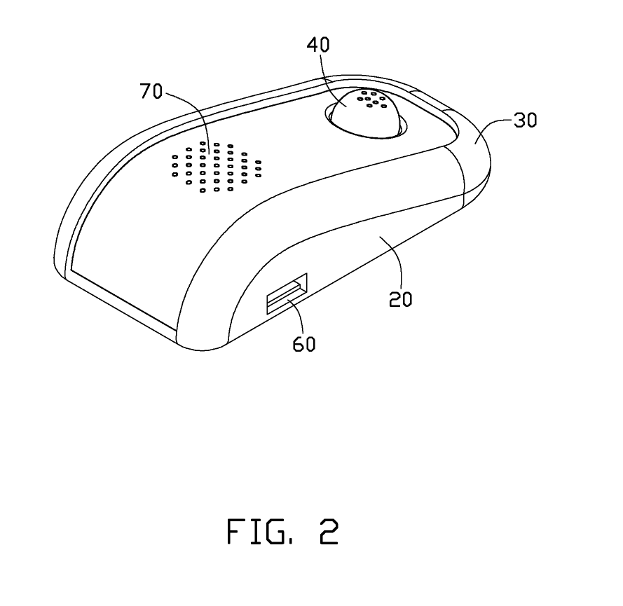

The FIG. 2 is a schematic view of the multi-functional mouse in FIG. 1 shown in another aspect.

### DETAILED DESCRIPTION

Referring to FIGS. 1 and 2, a mouse 100 includes an upper housing 10, a lower housing 20 mounted to the upper housing 10, a button 30 retractably mounted to the upper housing 10, a trackball 13 rotatably mounted on the upper housing 10, a first interface 50 and a second interface 60 which are both disposed on the lower housing 20; an audio output module 70 and an audio input module 80. The first interface 50 is an opening provided therein with attachment means to receive and electronically connect to a functional card such as Smart Media card (SMC), Compact Flash card (CFC), Secure Digital Memory Card (SDMC), or Trans Flash card (TFC). The second interface 60 is an opening provided therein to electrically connect with a USB device. In an exemplary embodiment, the first interface 50, the second interface 60, the audio output module 70 and the audio input module 80 all electronically connect to a wireless transceiver module 90 located between the upper housing 10 and the lower housing 20.

The wireless transceiver module 90 electronically connects the mouse 10 with an electronic device (e.g., computer), so that the wireless transceiver module 90 could convert current signals receiving from the first interface 50, the second interface 60 and/or the audio input module 80 into electromagnetic signals and transmit the electromagnetic signals to the electronic device, and/or receive and convert electromagnetic signals received from the electronic device into current signals and transmit the current signals to the first interface 50, the second interface 60 and/or the audio output module 70. In an alternative exemplary embodiment, the mouse 10 can be electronically connected to the electrical device by hard-wiring. The audio output module 70 converts electronic audio signals received from the wireless transceiver module 90 into sounds, so that the mouse 20 can playing audio files received from the electronic device. The audio input module 80 receives and converts sounds into audio signals and transmits the audio signals to the electronic device via wireless communication therebetween, so that the electronic device can receive sounds via the mouse 20.

The button 30 is located near a front end of the upper housing 10. The trackball 40 is positioned near the button 30. The audio input module 80 is preferably a microphone and is mounted in the trackball 40, and the trackball 40 defines a plurality of holes 82 corresponding to the audio input module 80, for facilitating the reception of audio signals to the audio input module 80. The audio output module 70 is preferably a speaker and is located in the upper housing 10, and the upper housing 10 defines a plurality of sound propagating ports 72 corresponding to the audio output module 70, for facilitating the output of audio signals of the audio output module 70.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A multi-functional mouse comprising:
an upper housing;
an lower housing mounted to the upper housing;
a first interface;
a second interface;
an audio output module converting electronic audio signals into sounds;
an audio input module receiving and converting sounds into audio signals and transmits the audio signals to electronic device; and
the mouse electronically communicating with the electronic device.

2. The multi-functional mouse as claimed in claim 1, wherein the mouse electronically communicates to the electronic device using a wireless transceiver module communicating with the electronic device via wireless communication technology; the wireless transceiver module, respectively and electrically, connecting to the first interface, the second interface, the audio output module and the audio input module.

3. The multi-functional mouse as claimed in claim 2, wherein the first interface is a card reader module.

4. The multi-functional mouse as claimed in claim 2, wherein the second interface is a USB module.

5. The multi-functional mouse as claimed in claim 2, wherein the multi-functional mouse further includes a button retractably mounted to the upper housing.

6. The multi-functional mouse as claimed in claim 2, wherein the multi-functional mouse further includes a trackball rotatably mounted on the upper housing.

7. The multi-functional mouse as claimed in claim 6, wherein the audio input module is mounted in the trackball.

8. The multi-functional mouse as claimed in claim 7, wherein the trackball defines a plurality of openings corresponding to the audio input module.

9. The multi-functional mouse as claimed in claim 2, wherein the first interface and the second interface are both mounted on the lower housing.

10. The multi-functional mouse as claimed in claim 2, wherein the audio output module is located in the upper housing.

11. The multi-functional mouse as claimed in claim 10, wherein the upper housing defines a plurality of holes corresponding to the audio output module.

12. The multi-functional mouse as claimed in claim 2, wherein the wireless transceiver module is Bluetooth or 2.4 G radio frequency.
